(19) United States
(12) Patent Application Publication
(10) Pub. No.: US 2010/0204395 A1
(43) Pub. Date: Aug. 12, 2010

(54) LIQUID COLOR CONCENTRATE FOR POLYESTER ARTICLES

(75) Inventor: Hari Rajaraman, Chardon, OH (US)

Correspondence Address: POLYONE CORPORATION, 33587 WALKER ROAD, AVON LAKE, OH, 44012, US

(73) Assignee: PolyOne Corporation, Avon Lake, OH (US)

(21) Appl. No.: 12/679,627

(22) PCT Filed: Sep. 23, 2008
(86) PCT No.: PCT/US08/77311

§ 371 Date: Mar. 23, 2010

Related U.S. Application Data
(60) Provisional application No. 60/974,616, filed on Sep. 24, 2007.

(51) Int. Cl. C08L 31/08; C09D 5/00

(52) U.S. Cl. 524/559; 106/287.26

(57) ABSTRACT

A liquid color concentrate is disclosed, having a polyalkylene polyol carrier; colorant; and optionally other functional additives. The colorant can be one or more pigments, one or more dyes, or combination thereof. The liquid color concentrate is compatible with polyalkylene terephthalate resins, especially to make colored polyester beverage bottles and other polyester articles.

### CLAIM OF PRIORITY

This application claims priority from U.S. Provisional Patent Application Ser. No. 60/974,616 bearing Attorney Docket Number 12007018 and filed on Sep. 24, 2007, which is incorporated by reference.

### FIELD OF THE INVENTION

This invention relates to use of a liquid polymer as a carrier for colorants used as a concentrate for making colored polyester articles.

### BACKGROUND OF THE INVENTION

Plastic has taken the place of other materials in a variety of industries. In the packaging industry, plastic has replaced glass to minimize breakage, reduce weight, and reduce energy consumed in manufacturing and transport. In other industries, plastic has replaced metal to minimize corrosion, reduce weight, and provide color-in-bulk products.

Attracting consumers to purchase individually-sized or family-sized containers includes branding and trade dress. Among the elements of valuable trade dress is the color of the container. Moreover, such color may need to co-exist with translucency, transparency, or other special effects for the bottle.

Liquid colorants are being extensively to color polyester (such as polyethylene terephthalate or PET) articles, such as beverage bottles. Many of the applications in PET are tints and have very low loading of colorants. Some existing products base their carrier on a blend of sorbitan mono-oleate and dioctyl adipate. In many tint applications, this carrier system yields liquid dispersions with low viscosity. Unfortunately, liquid products with low viscosity have a poor shelf life, because the colorants tend to settle, and this could lead to color variation in blow molded PET bottles.

To counteract shelf life problems, often thickeners based on silica are added to the liquid color concentrate increase viscosity. But these silica-based thickeners are difficult to process and control of viscosity during processing becomes difficult.

### SUMMARY OF THE INVENTION

What the art needs is a liquid carrier for color concentrates for polyester articles that has sufficient viscosity to forestall shelf life problem and avoid the use of silica-based thickeners.

The present invention solves the problem in the art by using a liquid polyethylene glycol as a carrier for color concentrates for polyester articles.

One aspect of the invention is a color concentrate for polyester articles, comprising: (a) a carrier comprising a liquid polyalkylene polyol (b) colorant; and optionally (c) at least one functional additive.

One feature of the present invention is that compounding the color concentrate of the present invention using polyethylene polyol as the carrier permits proper viscosity for good processing and storage and also permits letdown into the compounding equipment, via a fluid addition to the equipment.

Another feature of the present invention is that the colorant can include pigment(s), dye(s), or both as needed by the polymer engineer and product designer to achieve desired color effects.

Other features will become apparent from a description of the embodiments of the invention.

### EMBODIMENTS OF THE INVENTION

Liquid Polyalkylene Polyol

The liquid carrier can be a liquid polymer (homopolymer or copolymer) of one or more alkyl polyols. Of the possible candidates, polyalkylene glycols are preferred. Of those, polyethylene glycol is most preferred.

Suitable polyalkylene glycols should have a weight average molecular weight ranging from about 200 to about 8000, and preferably from about 200 to about 800, and most preferably about 200, which is why the preferred polyethylene glycol product is referred to as PEG 200.

The liquid polymer can have a glass transition temperature ranging from about −15° C. to about 100° C., and preferably from about 10° C. to about 60° C. and most preferably about 25° C.

Non-limiting examples of commercially available polyalkylene polyol include Pluracol E200 from BASF and Lumulse PEG 200 brand polyethylene glycol from Lambent Technologies of Gurnee, Ill., USA. These branded products are offered to the market as PEGs Of them, Lumulse PEG 200 is particularly preferred, because polyethylene glycol is particularly compatible with polyesters such as polyethylene terephthalate (PET), polytrimethylene terephthalate (PTT), and polybutylene terephthalate (PBT).

Colorant

As explained above, colorant can be a pigment, a dye, a combination of pigments, a combination of dyes, a combination of pigments and dye, a combination of pigment and dyes, or a combination of pigments and dyes. The choice of colorants depends on the ultimate color desired by the designer for the plastic article.

The science of color is well known to those skilled in the art. Without undue experimentation, one can use color matching techniques to identify a particular location in spherical color space. For example, one skilled in the art can use the teachings of PCT Patent Application US2004/012233 to digitally map color space using specific polymer carriers and colorants as raw material ingredients. Alternatively, one can make small samples called plaques for visual review.

Colorants are commercially available from a number of sources well known to those skilled in the art. Commercially available pigments are well known to those skilled in the art and include organic and inorganic colorant chemistries. Commercially available dyes are well known to those skilled in the art and include all organic chemistries. Commercial sources for pigments and dyes include multinational companies such as BASF, Bayer, Ciba-Geigy, Color-Chem International, Sun Chemical, Zhuhai Skyhigh Chemicals, and others identified at Internet Web Sites such as http://www.colorpro.com/info/vendors/colorant.html and http://dir.yahoo.com/Business and Economy/Business to Business/Chemicals and Allied Products/Pigments and Dyes/

Table 1 lists 8 commercially available pigment colorants in a variety of primary and secondary colors, 5 chromatics, 2 blacks, and 1 white.

TABLE 1
Commercial Pigment Colorants

| Raw Material | | | | |
|---|---|---|---|---|
| Name | CI_Name | Family | COLOR | FDA* |
| TIOXIDE | PIGMENT | INORGANIC | WHITE | Y |
| R-FC6 WHITE | WHITE 6 | | | |
| REGAL 660R | PIGMENT | ORGANIC | | N |
| BLACK | BLACK 7 | | | |
| POWDER | | | | |
| MPC CHANNEL | PIGMENT | ORGANIC | | Y |
| BLACK | BLACK 7 | | | |
| HELIOGEN | PIGMENT | ORGANIC | BLUE | Y |
| BLUE K7090 | BLUE 15:3 | | | |
| Heliogen | PIGMENT | ORGANIC | BLUE | Y |
| Blue K6903 | BLUE B 15:1 | | | |
| 34L2000 | PIGMENT | INORGANIC | BLUE | Y |
| AZURE BLUE | BLUE 28 | | | |
| SICOTAN | PIGMENT | INORGANIC | YELLOW | Y |
| YELLOW | BROWN 24 | | | |
| K 2001 FG | | | | |
| SICOTAN | PIGMENT | INORGANIC | YELLOW | Y |
| YELLOW | YELLOW 53 | | | |
| K 1011 | | | | |

*As publicized by the commercial producer or as tested by the applicant, or both.

Table 2 shows 14 commercially available dyes.

TABLE 2
Commercial Dye Colorants

| Raw Material | | | | |
|---|---|---|---|---|
| Name | CI Name | Family | Color | FDA* |
| Lambdaplast | Solvent | Anthraquinone | Blue | N |
| Blue NL | Blue 59 | | | |
| Macrolex | Solvent | Anthraquinone | Blue | N |
| Blue RR | Blue 97 | | | |
| Granular | | | | |
| Macrolex | Solvent | Anthraquinone | Green | N |
| Green G | Green 28 | | | |
| Granular | | | | |
| Macrolex | Solvent | Anthraquinone | Green | N |
| Green 5B | Green 3 | | | |
| Granular | | | | |
| Macrolex | Disperse | Polymethine | Orange | N |
| Orange R | Orange 47 | | | |
| Granular | | | | |
| Macrolex | Solvent | Perinone | Orange | N |
| Orange 3G | Orange 60 | | | |
| Granular | | | | |
| Macrolex | Solvent | Perinone | Red | N |
| Red EG | Red 135 | | | |
| Granular | | | | |
| Macrolex | Solvent | Perinone | Red | N |
| Red E2G | Red 179 | | | |
| Granular | | | | |
| Thermoplast | Solvent | Anthraquinone | Red | N |
| Red 454 | Red 195 | | | |
| Macrolex Red | Disperse | Anthraquinone | Violet | N |
| Violet R | Violet 26 | | | |
| Granular | | | | |
| Macrolex | Solvent | Anthraquinone | Violet | N |
| Violet B | Violet 13 | | | |
| Granular | | | | |
| Macrolex | Solvent | Anthraquinone | Violet | N |
| Violet 3R | Violet 36 | | | |
| Granular | | | | |
| Key Plast | Solvent | Pyrazolone | Yellow | N |
| Yellow 3G | Yellow 93 | | | |
| Key Plast | Solvent | Quinophthalone | Yellow | N |
| Yellow AG | Yellow 114 | | | |

*As publicized by the commercial producer or as tested by the applicant, or both.

both.

Preferably, colorants include colorants intended for transparent or translucent plastic polyester articles, although colorants intended for opaque plastic articles are not excluded from consideration.

Achievement of a color match of a plaque with a desired color from the creativity of a designer or a pre-arranged color standard such as Pantone® color standards from an inventory of commercially available colorants is relatively straightforward for a skilled color matcher, even if a few iterations are required to satisfy the customer.

The concentration of colorant into a carrier is significant because of the relative cost of the colorant ingredient(s) and the need for that color to consistently and precisely mix and disperse into the carrier and then to consistently and precisely dilute into the plastic resin and other compound ingredients during “letdown” of the concentrate in mixing equipment prior to formation of the pre-form embryonic bottles or other articles. Letdown ratios depend on the concentration of colorant in the color concentrate and whether the final molded product is intended to be opaque, translucent, or transparent.

Concentration of concentrate after letdown into the final molded product can range from about 0.05 to about 0.2 weight percent, and preferably from about 0.1 to about 0.5 weight percent.

The mixing equipment used to make the liquid color concentrate can be any suitable equipment already used in the art of making liquid color. For example, such equipment includes high speed “Cowles” type dispersors, media mills, three-roll mills and rotor-stator type dispersors

Mixing equipment can operate at mixing speeds ranging from about 100 rpm to about 10,000 rpm, and preferably from about 500 to about 8000 rpm. Mixing equipment can operate at temperatures ranging from about 25° C. to about 100° C., and preferably from about 40° C. to about 80° C.

Optional Functional Additives

Additives to improve processing or performance of the concentrate of the present invention or the polyester compound, or both, can be added according to preferences of this skilled in the art. For example, functional additives for polyester bottles can include anti-oxidants, anti-stats, acetaldehyde scavengers, blowing agents, biocides, exfoliated nanoclays, thickeners, and the like. Generally, minor amounts of such additives provide improvement of performance to the color concentrate during processing with the other ingredients in the polyester resin or in performance of the polyester molded article after manufacturing. One skilled in the art without undue experimentation can determine the appropriate concentration.

Frequently, the preparation of a colored plastic article does not involve merely color but also special effect features, such as Granite, Translucent, Pearls, Metallics, Fluorescents, Iridescents, Marbles, etc.

Non-limiting examples of such additives are commercially available from PolyOne Corporation of Avon Lake, Ohio, USA (www.polyone.com) and marketed under the following brands: OnColor FX colorants, PolyOne colorants, etc.

Plastic articles exposed to natural sunlight are exposed to ultraviolet rays that can harm the color of the article. Therefore, it is customary but not required to include ultraviolet light stabilizers in the color concentrate. This optional additive being included in the color concentrate adds value to that concentrate as a masterbatch in polymer compounding because the ultraviolet stabilizer also helps protect the polymer resin from adverse effects arising from exposure to the ultraviolet rays. Being included in a masterbatch as an additive makes the introduction of the stabilizer easier, due to better dispersion.

Commercially available stabilizers are well known to those skilled in the art and include thermal stabilizers and Tinuvin brand stabilizers from Ciba-Geigy of Berne, Switzerland. Of the choice of stabilizers, Tinuvin brand stabilizers are preferred, particularly Tinuvin 234 stabilizer.

Table 3 shows the acceptable, desirable and preferred weight percents of ingredients for color concentrates of the present invention.

TABLE 3

| Ingredient | Acceptable | Desirable | Preferred |
|---|---|---|---|
| (Wt. %) | Range | Range | Range |
| Polyalkylene | 15-98% | 20-95% | 60-95% |
| polyol | | | |
| Colorant | 2-75% | 5-60% | 10-40% |
| Optional | 0-20% | 0-10% | 0-5% |
| Functional | | | |
| Additives | | | |

### USEFULNESS OF THE INVENTION

Color concentrates of the present invention can be letdown into plastic resins and other ingredients useful for making molded or extruded articles in ratios ranging from about 0.01% to about 2.0%, and preferably from about 0.15% to about 0.50%.

As stated previously, the plastic resins can be any polyester, but especially PET.

The plastic article can be opaque, translucent, or transparent even though it has color from concentrates of the present invention. Precise color matching and consistent metering of color in amounts as little as 0.08 weight percent of concentrate can be achieved.

Other embodiments appear in the examples.

### Examples

Table 4 shows an example of the invention compared with a typical commercial sample. Both were made by milling, using a three roll mill of lab scale size. The viscosity of the two experiments is also reported.

TABLE 4

| Ingredient | 1 | Comp. A |
|---|---|---|
| Macrolex Violet B dye from | 1.33% | 1.33% |
| Lanxess | | |
| Macrolex Blue RR dye from | 0.88% | 0.88% |
| Lanxess | | |
| Cab-O-Sil M5 silica thickener | 1.0% | 3.0% |
| from Cabot Corporation | | |
| Sorbitan Mono-Oleate carrier | | 47.39% |
| from Uniqema | | |
| Dioctyl adipate carrier from | | 47.40% |
| Harwick Standard | | |
| PEG 200 carrier from Lambent | 96.79% | |
| Technologies | | |
| Viscosity (cps) according to | 1000 | 400 |
| Brookfield Viscometer, RV Type, | | |
| Spl#5, 10 rpm | | |

The viscosity of Example 1 is superior by 2.5 times over Comparative Example A, for good shelf life and ease of pumping.

Molding trials were conducted by having bottles blown from the combination of 99.95 weight percent PET resin with 0.05 weight percent of the Example 1 color concentrate. The bottles had good clarity and acceptable color. A single stage Aoki PET stretch blow molding machine was employed for this purpose. The melt temperature at the blow molding machine was around 274° C.

The invention is not limited to the above embodiments. The claims follow.

What is claimed is:

1. A color concentrate for polyester articles, comprising:
(a) a carrier comprising a liquid polyalkylene polyol;
(b) colorant; and
optionally (c) at least one functional additive.

2. The concentrate of claim 1, wherein the colorant comprises a pigment, a dye, a combination of pigments, a combination of dyes, a combination of pigments and dye, a combination of pigment and dyes, or a combination of pigments and dyes.

3. The concentrate of claim 1, wherein the polyalkylene polyol is a polyethylene glycol having a weight average molecular weight ranging from about 200 to about 8000.

4. The concentrate of claim 1, wherein the polyalkylene polyol is a polyethylene glycol having a weight average molecular weight ranging from about 200 to about 400.

5. The concentrate of claim 1, wherein the polyalkylene polyol is a polyethylene glycol having a glass transition temperature ranging from about 10° C. to about 60° C.

6. The concentrate of claim 1, wherein the polyalkylene polyol is a polyethylene glycol having a glass transition temperature ranging from about 25° C. to about 35° C.

7. The concentrate of claim 1, wherein the polyalkylene polyol is a polyethylene glycol and is present in the concentrate in an amount ranging from about 15 to about 98 weight percent, wherein the colorant is present in the concentrate in an amount ranging from about 2 to about 75 weight percent, wherein the optional surfactant is present, if at all, in an amount ranging up to 20 weight percent, and wherein the optional functional additive is present, if at all, in an amount ranging up to 20 weight percent.

8. The concentrate of claim 1, wherein the polyalkylene polyol is a polyethylene glycol and is present in the concentrate in an amount ranging from about 60 to about 95 weight percent, wherein the colorant is present in the concentrate in an amount ranging from about 10 to about 40 weight percent, wherein the optional surfactant is present, if at all, in an amount ranging from about 0.5 to about 1.5 weight percent, and wherein the optional functional additive is present, if at all, in an amount ranging up to 5 weight percent.

9. The concentrate of claim 1, wherein the concentrate is combined with a polyalkylene terephthalate resin, wherein the combination forms a colored polyester article.

10. The concentrate of claim 9, wherein the weight of concentrate in the polyalkylene terephthalate resin ranges from about 0.01 weight percent to about 2.0 weight percent.

11. The concentrate of claim 10, wherein the polyester article is opaque, translucent, or transparent.

12. A plastic article, comprising a concentrate of claim 1 let down into a polyalkylene terephthalate resin.

13. The article of claim 12, wherein the weight of concentrate in the polyalkylene terephthalate resin ranges from about 0.01 weight percent to about 2.0 weight percent.

14. The article of claim 13, wherein the polyester article is opaque, translucent, or transparent.

15. The article of claim 14, wherein the polyester article is optically clear.

16. The article of claim 12, wherein the colorant in the concentrate comprises a pigment, a dye, a combination of pigments, a combination of dyes, a combination of pigments and dye, a combination of pigment and dyes, or a combination of pigments and dyes.

17. The article of claim 12, wherein the polyalkylene polyol in the concentrate is a polyethylene glycol having a weight average molecular weight ranging from about 200 to about 8000 and having a glass transition temperature ranging from about 10° C. to about 60° C.

18. The article of claim 12, wherein the article is opaque, translucent, or transparent.

19. The article of claim 12, wherein the polyalkylene polyol in the concentrate is a polyethylene glycol and is present in the concentrate in an amount ranging from about 15 to about 98 weight percent, wherein the colorant is present in the concentrate in an amount ranging from about 2 to about 75 weight percent, wherein the optional surfactant is present, if at all, in an amount ranging up to 20 weight percent, and wherein the optional functional additive is present, if at all, in an amount ranging up to 20 weight percent.

20. The article of claim 12, wherein the polyalkylene polyol in the concentrate is a polyethylene glycol and is present in the concentrate in an amount ranging from about 60 to about 95 weight percent, wherein the colorant is present in the concentrate in an amount ranging from about 10 to about 40 weight percent, wherein the optional surfactant is present, if at all, in an amount ranging from about 0.5 to about 1.5 weight percent, and wherein the optional functional additive is present, if at all, in an amount ranging up to 5 weight percent.
